(19) United States
(12) Patent Application Publication
(10) Pub. No.: US 2006/0039288 A1
(43) Pub. Date: Feb. 23, 2006

(54) Network status monitoring and warning method

(75) Inventors: Che-Nan Yang, Hsinchu (TW); Min Chen, Hsinchu (TW); Ray-Ming Hsu, Hsinchu (TW)

Correspondence Address: Welsh & Katz, Ltd.;Eric D. Cohen, 22nd Floor, 120 South Riverside Plaza, Chicago, IL, 60606, US

(73) Assignee: National Applied Research Laboratories National Center For High-performance Computing, Hsinchu (TW)

(21) Appl. No.: 10/919,709

(22) Filed: Aug. 17, 2004

(51) Int. Cl. H04L 12/26

(52) U.S. Cl. 370/241

(57) ABSTRACT

A network status monitoring and warning method is disclosed. A test packet is transmitted intermittently to a test host. The IP addresses of all connected devices that transmit this test packet are extracted as the path data to be compared with expert data. The different addresses are considered as the address of those devices with problems. Alarms are then sent to those problematic devices in order to maintain an optimized path connection status. Therefore, the service interruption time for all connection devices can be reduced and the network is always maintained at its best connection status.

### BACKGROUND OF THE INVENTION

1. Field of Invention

The invention relates to a method of monitoring the network status and, in particular, to a monitoring and warning method that confirms the connection statuses of all devices in an optimized path by testing whether the transmission path of a test packet is optimized.

2. Related Art

The rapid growth of the Internet has brought human life and work great convenience. It is also a means for many enterprises to enhance their competition powers. For example, most enterprises have built their dedicated websites to provide various kinds of services to create business opportunities.

Since the Internet is a mixed network of local area networks (LAN) and wide area networks (WAN) connected using various network conenction devices (such a routers, servers, hosts, and bridges) under a common protocol. However, unexpected problems may occur to each connection device or network sector. Such problems include hardware disorder, incorect conenction device settings, network load too large to be handled by the conneciton devices, etc. Any network load inbalance caused by the above-mentioned situations can reduce the overall network efficiency.

As shown in FIG. 1, when a computer executable platform 2 wants to download data from another computer executable platform 12 via various connection devices on the Internet, the optimized path should be: first connecting to the host 4, then connecting to the server 6 via the host 4, and finally connecting to the computer executable platform 12 via the server 6.

Suppose the server 6 cannot respond to the request from the host 4 due to an unclear reason (e.g. the server breaks down or overloads), the host 4 will connect to the server 8, and to the host 10, and to the computer executable platform 12 for data downloading.

When the server 6 cannot operate normally, loads on the server 8 and the host 10 can increase to result in other unexpected situations.

To prevent these situations, current network management departments use all kinds of monitoring method to ensure that each connection device (node) on the network can function normally. For example, the display light on the channel service unit/digital service unit (CSU/DSU) determines whether a transmission connection breaks.

Another common method is to use a test device (such as the protocol analyzer) to check the connection statuses of all connection devices. However, the cost is usually much higher than normal users can afford.

The most commonly used method is to use a built-in application program of the operating system to check the connection statuses. Examples include tracerout in the UNIX system as proposed by International Business Machines (IBM), Inc and tracert in Windows developed by Microsoft. However, these programs can only show the connection statuses of the connection devices, but not check whether a packet is transmitted through the optimized path.

Therefore, it is highly desirable to provide a method that can keep all connection devices in their connected statuses while at the same time making packets transmit through the optimized path. Furthermore, the method should be able to reduce the service interruption time of the connection devices (by automatically notifying or solving the connection problem) so that one can obtain the best-quality Internet services.

### SUMMARY OF THE INVENTION

An objective of the invention is to provide a network status monitoring and warning method. The network managing unit for control network statuses. The method routinely sends test packets to check whether they are transmitted through an optimized path in order to determine the connection statuses of all connection devices (such as routers, servers, hosts, and bridges). When any problem occurs to one of the connection devices, it automatically provides a warning signal to restart the connection device or to notify the relevant network managing unit. Thus, the breakdown connection device can be recovered within the shortest possible time.

The method includes the steps of: extracting the IP addresses of connection devices along the path traversed by a test packet transmitted to a test host as path data; extracting expert data to determine IP addresses of all connection devices on the optimized path of the test packet to the test host; comparing the path data with the expert data; extracting the IP address of any connection device form the expert data that has different entries with the path data; transmitting a warning signal to the connection device for it to provide normal services again.

The disclosed method can be further applied to a network sector that uses autonomous system numbers (ASN) as network identification data so that that network sector composed of the ASN. The main procedure is the same as the above-mentioned method that uses IP addresses as the comparison data. The only difference between these two embodiments is that when checking whether the connection status of the network sector composed of the ASN is normal, the comparison data are the ASN.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the access path for a computer executable platform to store or retrieve data via the Internet;

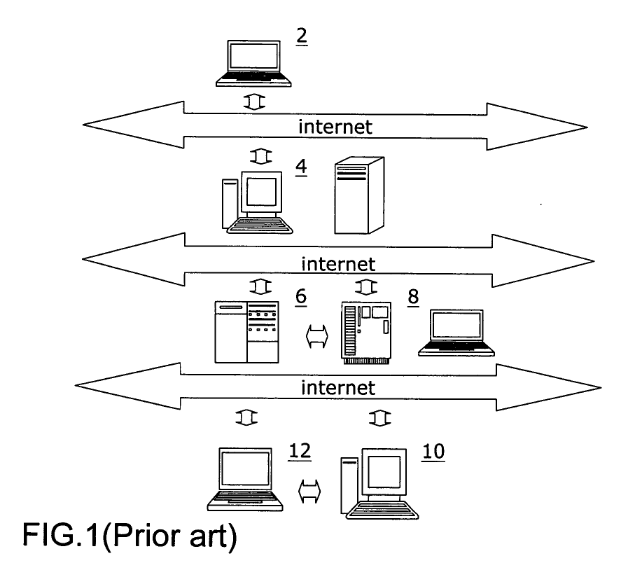

FIG. 2 is a flowchart of the first embodiment of the disclosed method;

FIG. 3 is a schematic view of comparing the expert data with the path data according to the invention; and

FIG. 4 is a flowchart of the second embodiment of the disclosed method.

### DETAILED DESCRIPTION OF THE INVENTION

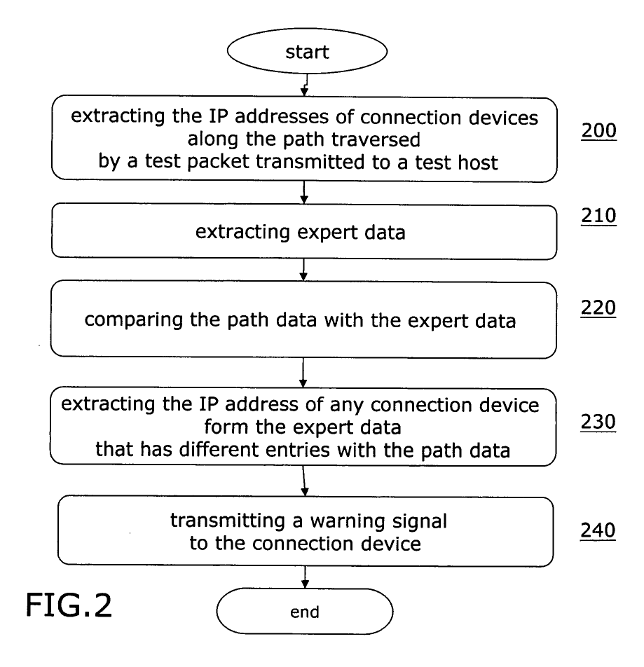

A first embodiment of the invention is shown in FIG. 2. The main procedure is descrbed as follows. First, a test packet is transmitted via a network to a test host to extract path data. The path data contain the IP addresses of the connection devices traversed by the test packet (step 200). The test packets are routinely transmitted to the test host using a timer. In practice, the connection devices may be routers, servers, hosts, and bridges etc.

Afterwards, expert data are extracted (step 210). The expert data record the IP addresses of all connection devices on the optimized path for the test packet to be sent to the test host. The optimized path is the path with the minimal connection devices for the test packet to go to the test host.

Afterwards, the path data and the expert data are compared (step 220). The IP addresses of each connection device recorded in the two data sets are compared. Following the comparison result, the IP address of the connection device with different IP addresses in the expert data and the path data is extracted from the expert data (step 230). If the comparison result does not show complete agreement, the method determines that the test packet is not transmitted according to the optimized path. Thus, the connection devices in the optimized path may have problems. The different IP addresses in expert data are considered as those of the connection devices with problems. If the comparison result shows complete agreement, then the test packet is transmitted along the optimized path and all connection devices are functioning normally. Finally, a warning signal is sent to the connection device with an extracted IP address (step 240). The warning signal can be an electronic mail or system reset signal. When the warning signal is an electronic mail, the mail shows the time the test packet is sent out and the transmission statuses of the test packet in all the conneciton devices (such as the connection time, transmission rate, etc) for the network managing unit's reference. When the warning signal is a system rest signal, the signal makes the connection device with the extracted IP address reset the system status (restart).

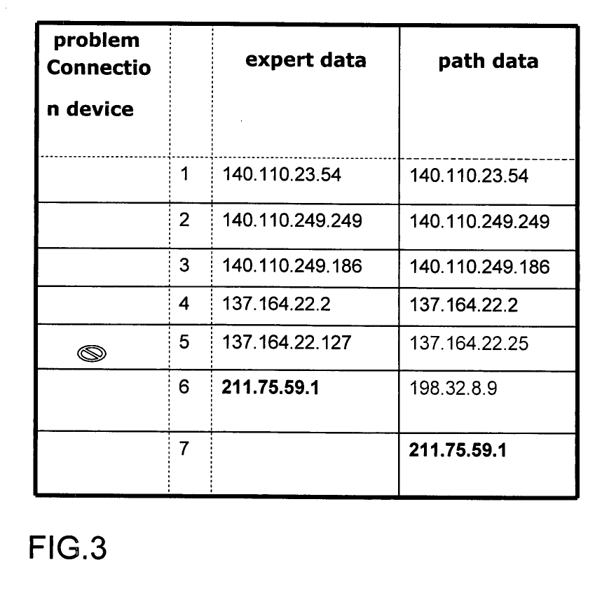

As shown in FIG. 3, suppose the IP address of the host that sends out the test packet is 140.110.23.54 and that of the test host receiving the test packet is 211.75.59.1. The optimized path for transmitting the test packet according to the expert data should pass threough four connection devices, with the IP addresses 140.110.249.249, 140.110.249.186, 137.164.22.2, and 137.164.22.127.

However, the path data shows that the test packet actually passes five connection devices, with the IP addresses 140.110.249.249, 140.110.249.186, 137.164.22.2, 137.164.22.25, and 198.32.8.9 According to the comparison result, the connection device with the IP address 137.164.22.127 does not respond immediately when the test packet is transmitted to it. Therefore, the connection device with the IP address 137.164.22.2 selects another connection device (router), such as the one with the IP address 137.164.22.25, to keep transmitting the test packet.

As described above, when the connection device with the IP address 137.164.22.2 abandons the optimized path and sends the test packet via another connection device, it means that the connection device unable to respond immediately (with the IP address 137.164.22.127) may have some problem. Therefore, the network managing unit has to check its connection status.

Moreover, the connection method of some connection devices may use the exterior gateway protocol (EGP), the border gateway protocol (BGP), or the OSI inter-domain routing protocol (RDRP) to connect to the network. These protocols use the autonomous system number (ASN) as the identification data of the connection devices on the network. As a result, they cannot use IP addresses as the comparison data. Therefore, we further provide a second embodiment that uses the ASN as the comparison data.

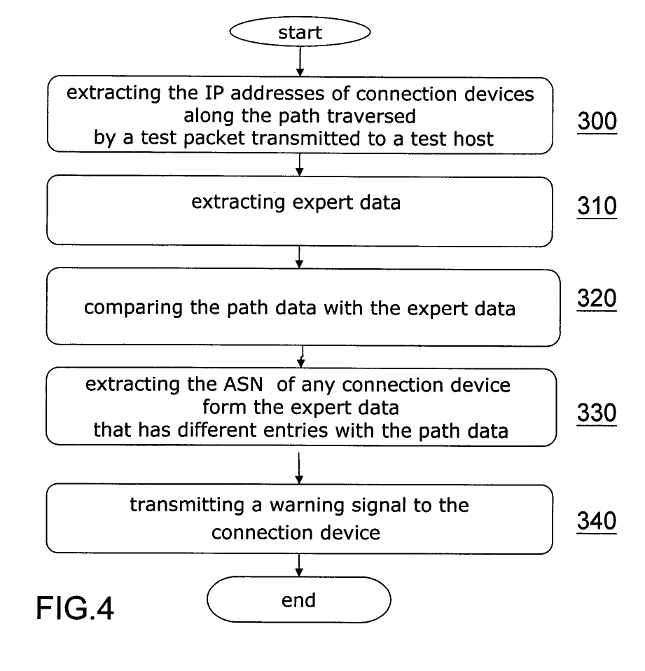

FIG. 4 shows the procedure of the second embodiment, which is basically the same as the first embodiment. First, a test packet is transmitted via a network to a test host to extract path data, which include the ASN of all the connection devices that the test packet goes through (step 300). Afterwards, expert data are extracted (step 310). The expert data contain the ASN of all the connection devices on the optimized path for the test packet to reach the test host. Afterwards, the path data and the expert data are compared (step 320). According to the comparison result, the ASN of the connection device with different entries in the expert data and the path data is extracted from the expert data (step 330). Finally, a warning singal is sent to the connection device with the extracted ASN (step 340).

Not only can the invention automatically detect the connection statuses of all connection devices on the network, it can further send out an immediate warning when any connection device experiences a problem. Therefore, the invention can be used to keep all the connection devices at their best service states. The user can thus receive or transmit data via the optimized path.

Certain variations would be apparent to those skilled in the art, which variations are considered within the spirit and scope of the claimed invention.

What is claimed is:

1. A network status monitoring and warning method, which comprises the steps of:
transmitting a test packet to a test host in order to extract path data, the path data containing the IP addresses of at least one connection devices traversed by the test packet as it travels to the test host;
extracting expert data to determine IP addresses of all connection devices on an optimized path of the test packet to the test host;
comparing the path data with the expert data;
extracting the IP address of any connection device form the expert data that has different entries with the path data; and
transmitting a warning signal to the connection device whose IP address is extracted.

2. The network status monitoring and warning method of claim 1, wherein the test packet is generated and sent routinely by a timer.

3. The network status monitoring and warning method of claim 1, wherein the connection devices are selected from the group consisting of routers, servers, hosts, and bridges.

4. The network status monitoring and warning method of claim 1, wherein the warning signal is an electronic mail.

5. The network status monitoring and warning method of claim 1, wherein the warning signal is a system reset signal.

6. The network status monitoring and warning method of claim 5, wherein the system reset signal makes the connection device with the extracted IP address to restart its system state.

7. A network status monitoring and warning method, which comprises the steps of:
transmitting a test packet to a test host in order to extract path data, the path data containing the autonomous system numbers (ASN) at least one connection devices traversed by the test packet as it travels to the test host;
extracting expert data to determine ASN of all connection devices on an optimized path of the test packet to the test host;
comparing the path data with the expert data;
extracting the ASN of any connection device form the expert data that has different entries with-the path data; and
transmitting a warning signal to the connection device whose ASN is extracted.

8. The network status monitoring and warning method of claim 7, wherein the test packet is generated and sent routinely by a timer.

9. The network status monitoring and warning method of claim 7, wherein the connection devices are selected from the group consisting of routers, servers, hosts, and bridges.

10. The network status monitoring and warning method of claim 7, wherein the warning signal is an electronic mail.

11. The network status monitoring and warning method of claim 7, wherein the warning signal is a system reset signal.

12. The network status monitoring and warning method of claim 11, wherein the system reset signal makes the connection device with the extracted IP address to restart its system state.
